(19) United States
(12) Patent Application Publication
(10) Pub. No.: US 2006/0154546 A1
(43) Pub. Date: Jul. 13, 2006

(54) Air permeable pressure-sensitive adhesive tapes

(75) Inventors: Thomas S. Murphy, Boxford, MA (US); Stanley J. Piaseczynski, Epping, NH (US)

Correspondence Address: WILMER CUTLER PICKERING HALE AND DORR LLP, 60 STATE STREET, BOSTON, MA, 02109, US

(73) Assignee: Andover Coated Products, Inc.

(21) Appl. No.: 11/204,736

(22) Filed: Aug. 16, 2005

Related U.S. Application Data
(63) Continuation-in-part of application No. 10/603,224, filed on Jun. 25, 2003.

(51) Int. Cl. B32B 27/12; B32B 5/24; B32B 3/26; B32B 7/12

(52) U.S. Cl. 442/286; 442/189; 442/221; 428/304.4; 428/317.1

(57) ABSTRACT

A vapor permeable article includes a porous backing substrate and an open fabric applied to one surface of the backing substrate. The open fabric has a greater porosity than that of the backing substrate. The open fabric may be a woven fabric comprising warp (MD) yarns and weft (CD) yarns, and the warp yarns may be of a lower denier than the weft yarns, so as to facilitate hand-tear of the assembled article. The open fabric is coated with an adhesive in such a manner that the open fabric remains porous and vapor permeable. The backing substrate can be a woven, knit or non-woven fabric, or a porous film, such as an apertured plastic film.

### CROSS REFERENCE TO RELATED APPLICATIONS

This application is a continuation-in-part of U.S. application Ser. No. 10/603,224, filed Jun. 25, 2003.

### 1. FIELD OF THE INVENTION

The present invention is directed to pressure-sensitive adhesive articles, and more particularly to water vapor permeable, pressure-sensitive adhesive articles. In particular, the invention relates to breathable, pressure-sensitive adhesive products that are readily and evenly tearable in the cross direction. The invention further relates to sheets or tapes made from the adhesive articles and methods for making the adhesive article.

### 2. BACKGROUND OF THE INVENTION

Pressure-sensitive adhesive materials are made up of an adhesive composition applied to a porous backing. The use of pressure-sensitive adhesive-coated sheet materials in the form of adhesive tapes, medical and surgical bandages, and surgical drapes for the management of skin wounds and to adhere or to secure medical devices such as intravenous needles is a widely used and well-accepted medical practice. Pressure-sensitive adhesive-coated tapes are also widely used in sports medicine for protection and safety of athletes, for example, for the wrapping of joints subject to stress during performance, as well as for treating injuries.

Pressure-sensitive adhesive-coated tapes generally are designed to adhere to a surface that is a source of moisture such as skin. The adhesive tape is desirably porous and breathable so that the moisture of the skin can be vented from the skin surface. When adequate moisture venting is not available, the accumulated water overhydrates and softens the outer layers of the skin (stratum corneum), thereby causing skin maceration. Further, the stratum corneum of the macerated skin is further damaged when the pressure-sensitive adhesive-coated sheet material is removed. Therefore, in order to prevent moisture-caused maceration of skin, the pressure-sensitive adhesive-coated sheet materials should preferably be composed of water vapor permeable substrate backings and non-irritating pressure-sensitive adhesives.

An additional desirable feature of pressure-sensitive adhesive tapes is uniform tear characteristics. The tape should tear easily and evenly in the cross direction when pressure is applied at a specific point along the edge. The adhesive tape also should have adequate strength so that the tape does not tear or break during application or normal use.

Pressure-sensitive adhesive compositions are commonly applied to breathable backings or tapes by coating the backings or tapes with an adhesive solution or dispersion in a suitable vehicle such as an organic solvent or water and evaporating the vehicle, or by coating the backings or tapes with an adhesive in the form of a hot melt. When the adhesive coating is applied as a continuous layer, however, the breathability of the porous backing diminishes significantly or is eliminated entirely.

A discontinuous adhesive coating on a breathable backing allows the skin to breathe, at least in the areas of the backing not coated with the adhesive. Thus, prior art processes have attempted to disrupt the continuity of the adhesive film coating to deposit a discontinuous film. Adhesive-backed tapes have been perforated using needle-like points to mechanically pierce the adhesive-backed tape after the application of the adhesive coating. Gas streams directed onto regions of the adhesive-coated porous web have also been used to form perforations in the adhesive-coated web at predetermined positions. Other techniques use intermittent coating of adhesives onto the backing. For example, adhesive is applied using patterned rolls, screen printing and release coated calendar roll processing similar to Gravure printing.

U.S. Pat. No. 2,740,403 describes a two-ply bandage having either a closely woven fabric or a flexible perforated plastic film backing, and an adhesive-coated open weave inner fabric layer. Although the open weave inner fabric is said to retain its porosity upon being coated with adhesive, it is only marginally more porous than either the closely woven fabric backing or the flexible perforated plastic film backing, and the breathability of the bandage is not improved significantly. In particular, U.S. Pat. No. 2,740,403 does not describe an open weave inner fabric that is sufficiently open so as to remain 15-30% open area after adhesive has been applied to it in the assembled article.

Pressure-sensitive adhesive tapes desirably maintain a minimum water vapor transmission (WVT) rate to allow for constant breathing of the skin when covered with the tape; however, the vapor permeability of prior art pressure-sensitive adhesive tapes is still unacceptably low for many applications.

### 3. SUMMARY OF THE INVENTION

The present invention provides a water vapor permeable, pressure-sensitive adhesive article that is at once both convenient to use and economical to manufacture.

In one aspect, the invention provides an air permeable adhesive article that includes a porous backing substrate and an adhesive-carrying fabric that is applied to a surface of the backing substrate. In this aspect, the fabric of the adhesive-carrying fabric has a porosity that is greater than that of the backing substrate prior to application of the adhesive, and the adhesive of the adhesive-carrying fabric is applied to the fabric in such a manner that the air permeable adhesive article has an overall air permeability of at least about 100 ft³/minute. In certain embodiments, the air permeable adhesive article has an overall air permeability of at least about 125 ft³/minute. In other embodiments, the air permeable adhesive article has an overall air permeability of at least about 150 ft³/minute. In certain particularly useful embodiments, the air permeable adhesive article has an overall air permeability of at least about 200 ft³/minute.

In another aspect, the invention provides an air permeable adhesive article that includes a porous backing substrate having at least about 20% open area, and an adhesive-carrying fabric applied to a surface of the backing substrate, the fabric of the adhesive-carrying fabric having at least about 25% open area before application of the adhesive. In certain embodiments, the fabric of the adhesive-carrying fabric layer of the adhesive article has at least about 30% open area before application of the adhesive. In other embodiments, the fabric of the adhesive-carrying fabric layer of the adhesive article has at least about 30% open area before application of the adhesive. In certain particularly useful embodiments, the fabric of the adhesive-carrying fabric layer of the adhesive article has at least about 30% open area before application of the adhesive.

In yet another aspect, the invention provides an air permeable adhesive article that includes a porous backing substrate having at least about 20% open are, and an adhesive-carrying fabric applied to a surface of the backing substrate, the fabric having a porosity before application of the adhesive that is greater than that of the backing substrate, and the adhesive-carrying carrying fabric layer having an overall open area of at least about 15% of the surface area of the assembled article. In certain embodiments, the adhesive-carrying carrying fabric layer of the air permeable adhesive article has an overall open area of at least about 20% of the surface area of the assembled article. In other embodiments, the adhesive-carrying carrying fabric layer of the air permeable adhesive article has an overall open area of at least about 25% of the surface area of the assembled article. In certain particularly useful embodiments, the adhesive-carrying carrying fabric layer of the air permeable adhesive article has an overall open area of at least about 30% of the surface area of the assembled article.

In further particularly useful embodiments, the air permeable adhesive article has an overall open area that is at least 3%, usefully at least 4%, more usefully at least 5%, still more usefully at least 6%, and, most usefully, at least 10% of the overall surface area of the assembled article.

In another useful aspect, the invention provides an adhesive article that includes a porous backing substrate and an adhesive-carrying fabric applied to a surface of the backing substrate, the fabric having a porosity greater than that of the backing substrate and the adhesive of the adhesive-carrying fabric located on the fabric in such a manner that the fabric remains porous.

In a further aspect, the invention provides an adhesive article that includes a porous backing substrate and an adhesive-carrying fabric applied to a surface of the backing substrate, the fabric having a porosity greater than that of the backing substrate and comprising warp yarns running in the machine direction and weft yarns running in the cross direction, the weft yarns having a higher denier than the warp yarns, and the adhesive of the adhesive-carrying fabric located on the fabric in such a manner that the fabric remains porous.

In still another aspect, the invention provides an adhesive article that includes a porous backing substrate and an adhesive-carrying porous fabric having a first and a second surface. The adhesive is located on the porous fabric in such a manner that the adhesive-carrying fabric remains porous, and the first surface of the open fabric is applied to a surface of the backing substrate, while the second surface of the open fabric is substantially coated with adhesive, although the second surface of the adhesive-carrying porous fabric covers no more than 50% of the assembled adhesive article's surface area.

In particularly useful embodiments of each of the above aspects of the invention, the porous backing substrate of the air permeable adhesive article is a porous film. In other embodiments, the porous backing substrate of the air permeable adhesive article is a woven, knit or non-woven fabric. In still other embodiments, the adhesive-carrying fabric of the air permeable adhesive article is a woven, non-woven or knit fabric.

In further embodiments of these aspects of the invention, the fabric of the adhesive-carrying fabric layer of the air permeable adhesive article includes warp yarns running in the machine direction and weft yarns running in the cross direction. In particularly useful embodiments, the weft yarns having a higher denier than the warp yarns. In further embodiments, the warps yarns of the fabric layer of the air permeable adhesive article have a denier in the range of 20 to 80, and the weft yarns have a denier in the range of 50 to 200. In other embodiments, the warps yarns have a denier in the range of 40 to 60. In still other embodiments, the warps yarns of the fabric layer of the air permeable adhesive article have a denier in the range of 20 to 40. In further embodiments, the warps yarns have a denier in the range of about 30. In still further embodiments, the weft yarns of the fabric layer of the air permeable adhesive article have a denier in the range of 70 to 150. In other embodiments, the weft yarns have a denier in the range of about 70. In still further embodiments, the warp yarns of the fabric layer of the air permeable adhesive article have a density in the range of 9 yarns/inch to 24 yarns/inch. In other embodiments, the warp yarns have a density of about 18 yarns/inch. In still other embodiments, the weft yarns of the fabric layer of the air permeable adhesive article have a density in the range of 9 yarns/inch to 18 yarns/inch. In further embodiments, the weft yarns have a density of about 12 yarns/inch. In particular embodiments, the article has a tensile strength in the machine direction that is greater than the tensile strength in the cross direction. In certain embodiments, the warps yarns of the fabric layer of the air permeable adhesive article have a density in the range of 9 yarns/inch to 24 yarns/inch, and the weft yarns have a density in the range of 9 yarns/inch to 18 yarns/inch. In certain particularly useful embodiments, the warp yarns have a denier of about 30 and a density of about 18 yarns/inch, and the weft yarns have a denier of about 70 and a density of about 12 yarns/inch. In particularly useful embodiments, the air permeable adhesive article is hand-tearable in the cross direction.

In further embodiments, the air permeable adhesive article further includes elastic yarns that are extensible in the machine direction. In particular embodiments, the elastic yarns are positioned between the inner surface of the porous backing substrate and the adhesive-carrying fabric.

In further embodiments of the above aspects of the invention, an inner face of the porous backing substrate contacts and adheres to an inner face of the adhesive-carrying fabric. In certain embodiments, the adhesive bonds the inner face of the porous backing substrate to the inner face of the adhesive-carrying fabric.

In still further embodiments of the above aspects of the invention, the adhesive of the adhesive-carrying fabric is a pressure-sensitive adhesive. In further embodiments, the adhesive is a polyacrylate adhesive, a polyalphaolefin adhesive, a styrene-butadiene adhesive, a styrene-ethylene/butylenes adhesive, a styrene-isoprene adhesive, a polyvinyl acrylate adhesive, a natural rubber resin adhesive, a synthetic rubber resin adhesive, a silicone adhesive, a polydiorganosiloxane polyurea copolymer adhesive, a polyurethane adhesive, a urethane copolymer adhesive, or a mixture blend of two or more such adhesives. In particularly useful embodiments, the adhesive is an acrylic resin such as an acrylic multipolymer. In other embodiments the adhesive includes a tackifier. In particularly useful embodiments, the adhesive has sufficient internal cohesive strength that the article is removable from a substrate without separation of the backing substrate and the adhesive-carrying fabric. In certain particularly useful embodiments, the porous backing substrate of the air permeable adhesive article is an apertured plastic film and the adhesive is pressure-sensitive.

In still further embodiments of the above aspects of the invention, the porous backing substrate of the air permeable adhesive article is a porous film. In particularly useful embodiments, the porous backing substrate is a plastic film. In other embodiments the porous film is made from a material such as natural rubber, synthetic rubber, balata, or gutta-percha. In particular embodiments, the porous film is made from an elastomeric material such as polybutadiene, ethylene-propylene terpolymer (EPDM rubber), styrene-butadiene copolymer, polychloroprene (neoprene), nitrile rubber, butyl rubber, polysulfide rubber, silicone rubber, polyurethane rubber, polyisobutylene, natural rubber, or acrylate rubber, or a mixture of two or more such materials. In still other embodiments, the porous film may be constructed from a polysaccharide material, such as cellulose. In further embodiments, the polysaccharide porous film is a synthetic polysaccharide such as cellophane, cellulose nitrate (nitrocellulose), cellulose acetate, or cellulose acetate butyrate.

In particularly useful embodiments of the above aspects of the invention, the porous film is an apertured film, e.g., an apertured plastic film. In certain embodiments, the plastic is polyethylene. In other embodiments, the plastic is polyvinyl chloride, polypropylene, polystyrene, polyurethane or polyester (Mylar). In further embodiments, the plastic is a polymer or a co-polymer of a monomer such as ethylene, propylene, butylene, vinyl chloride monomer, styrene monomer, or urethane monomer. In certain particularly useful embodiments, the apertured plastic film is corona-treated prior to assembly of the article. In particular embodiments, the apertured film is made from a film material that is about 10 micrometers to about 300 micrometers thick. In particular embodiments, the apertured film is made from a plastic film that is about 0.0005 inches to about 0.010 inches (0.5 to 10 mils, 0.00127 to 0.0253 cm) thick. In other embodiments, the apertured plastic film is made from a plastic film that is about 0.001 inches to about 0.005 inches (1 to 5 mils) thick. In still other embodiments, the apertured plastic film is made from a plastic film that is about 0.0025 inches (2.5 mils) thick.

In particularly useful embodiments of the invention, the apertured film has at least about 20% open area. In certain embodiments, the apertured film has at least about 24% open area. In further embodiments, the apertured film has about 20% to about 30% open area. In particular embodiments, the apertured plastic film may be transparent, or translucent, or may be colored, e.g., colored white, yellow, orange, red, blue, green, violet, brown, or black. In further useful embodiments, the apertured plastic film is extensible in the machine direction by at least about 10%. In still further embodiments, the apertured plastic film is extensible in the machine direction by at least about 20%. In particularly useful embodiments, the apertured plastic film is extensible in the machine direction by about 24%.

In particularly useful embodiments of the above aspects of the invention, the porous backing substrate of the air permeable adhesive article is a porous film. In certain particularly useful embodiments, the porous film is an apertured plastic film, e.g., polyethylene or a copolymer of ethylene. In other embodiments, the porous backing substrate of the air permeable adhesive article is a woven, knit or non-woven fabric. In still other embodiments, the adhesive-carrying fabric of the air permeable adhesive article is a woven, non-woven or knit fabric.

In yet another aspect of the invention, a pressure-sensitive article includes a porous backing substrate and an adhesive-carrying fabric applied to a surface of the backing substrate. The fabric has a porosity greater than that of the backing substrate and the adhesive of the adhesive-carrying fabric is located on the fabric in such a manner that the fabric remains porous.

In another aspect of the invention, a pressure-sensitive article includes a porous backing substrate and an adhesive-carrying fabric applied to a surface of the backing substrate. The fabric has a porosity greater than that of the backing substrate, and the adhesive of the adhesive-carrying fabric is located on the fabric in such a manner that the adhesive-carrying fabric remains porous and the adhesive penetrates into a portion of a thickness of the porous backing.

In another aspect of the invention, a pressure-sensitive article includes a porous backing substrate and an adhesive-carrying porous fabric having first and second surfaces. The adhesive is located on the porous fabric in such a manner that the adhesive-carrying fabric remains porous. The first surface of the open fabric is applied to a surface of the backing substrate, and the second surface is substantially coated with adhesive, wherein the second surface covers no more than 50% of the article surface area. The second surface can cover as little as about 5% of the article surface area. The article adheres securely to a substrate, e.g., skin surface, yet can be easily removed without damage to the underlying tissue.

In a further aspect, the invention provides an article that includes a porous backing substrate and an adhesive-carrying fabric applied to a surface of the backing substrate, the fabric having a porosity greater than that of the backing substrate and having warp yarns running in the machine direction and weft yarns running in the cross direction, the weft yarns having a higher denier than the warp yarns, and the adhesive of the adhesive-carrying fabric located on the fabric in such a manner that the fabric remains porous.

In certain embodiments, the porous backing substrate is a woven fabric, a knit fabric or a non-woven fabric. In particular embodiments, the adhesive-carrying fabric is a woven fabric, a knit fabric or a non-woven fabric. In particularly useful embodiments, the porous backing substrate is a porous film. The porous film may be made from plastic, rubber, or a natural or synthetic polysaccharide. In certain embodiments, the polysaccharide is a synthetic such as cellophane, cellulose nitrate (nitrocellulose), cellulose acetate, or cellulose acetate butyrate. In other embodiments, the porous film is made of plastic, and the plastic is polyethylene. In further embodiments the porous film is a plastic such as polyethylene, polypropylene, polybutylene (polybutene), an ethylene copolymer, a propylene copolymer or a butylene copolymer. In still further embodiments the plastic porous film is polyvinyl chloride, polyproplylene, polystyrene, polyurethane or a polyester (such as Mylar). In particularly useful embodiments, the porous film is composed of a polyisoprene, such as natural rubber, synthetic rubber, balata, and gutta-percha. The porous film may also be composed of a polyisoprene such as cis-1,4-polyisoprene or trans-1,4-polyisoprene. In other embodiments, the porous film is composed of an elastomer. In particular embodiments, the elastomer is polybutadiene, ethylene-propylene terpolymer (EPDM rubber), styrene-butadiene copolymer, polychloroprene (neoprene), nitrile rubber, butyl rubber, polysulfide rubber, silicone rubber, polyurethane rubber, polyisobutylene, natural rubber, or acrylate rubber.

In particularly useful embodiments, the porous film is an apertured film, such as an apertured plastic film. In certain embodiments, the plastic film is polyethylene. In other embodiments, the plastic is polyvinyl chloride, polyproplylene, polystyrene, polyurethane or polyester (Mylar). In still other embodiments, the plastic is a polymer or a co-polymer of a monomer such as ethylene, propylene, butylene, vinyl chloride monomer, styrene monomer, or urethane monomer. In particularly useful embodiments, the porous film is a corona-treated apertured plastic film that has been corona-treated with a high voltage electrical discharge to improved adhesion to the adhesive-coated open fabric. In other embodiments, the porous film is treated with a gas flame or ozone, or a combination of such treatments, to improve adhesion.

In particularly useful embodiments, the apertured film is made from a film material that is about 10 micrometers to about 300 micrometers thick. In certain embodiments, the apertured film is an apertured plastic film that is about 0.0005 inches to about 0.010 inches (0.5 to 10 mils, 0.00127 to 0.0253 cm) thick. In some embodiments, the apertured plastic film is made from a plastic film that is about 0.001 inches to about 0.005 inches (1 to 5 mils) thick. In particular embodiments, the apertured plastic film is made from a plastic film that is about 0.0025 inches (2.5 mils) thick.

In further useful embodiments, the apertured film has at least about 10% open area, e.g., at least about 15% open area, at least about 20% open area, or at least about 24% open area. In particular embodiments, the apertured film has less than about 75% open area, e.g., less than about 60% open area, or less than about 50% open area. In certain embodiments, the apertured film has about 20% to about 30% open area, e.g., about 24% open area.

In further embodiments, the apertured plastic film is transparent. In other embodiments, the apertured plastic film is translucent. In still other embodiments, the apertured plastic film is colored, such as by virtue of pigment carried in the plastic of the apertured plastic film. In particular embodiments, the pigment of the apertured plastic film imparts a color such as white, yellow, orange, red, blue, green, violet, brown, or black.

In further useful embodiments, the apertured plastic film is extensible in the machine direction by at least about 10%, e.g., at least about 20%. In particular embodiments, the apertured plastic film is extensible in the machine direction by about 24%.

In still further embodiments of the invention the adhesive-carrying fabric is a warp knit fabric. In particular embodiments, the warp knit fabric further includes a weft insert yarn. In certain embodiments, the backing substrate and the adhesive-carrying fabric are of substantially the same elasticity and extensibility. In other embodiments, the adhesive-carrying fabric has more than 80% open area prior to application of the adhesive. In still other embodiments, the percent open area of the adhesive-carrying fabric is reduced by no more than about 10% upon application of the adhesive.

In particularly useful embodiments, the porous backing substrate is more than about 25% open area, e.g., more that about 50% open area. In certain embodiments, the adhesive of the adhesive-carrying fabric penetrates into the one surface of the backing substrate. For example, the adhesive may penetrate about 25% to 75% into the thickness of the backing substrate. In further embodiments, an inner face of the porous backing substrate contacts and adheres to an inner face of the adhesive-carrying fabric. In particular embodiments, the adhesive bonds the inner face of the porous backing substrate to the inner face of the adhesive-carrying fabric. In particularly useful embodiments, the porous backing substrate is an apertured plastic film that is adhered to an inner face of the adhesive-carrying fabric. In particularly useful embodiments, the porous backing substrate is an apertured plastic film and the adhesive is a pressure-sensitive adhesive.

In other embodiments, an inner face of the porous backing substrate contacts and adheres to an inner face of the adhesive-carrying fabric and the porous backing substrate is an apertured plastic film. In particularly useful embodiments, the porous backing substrate is an apertured plastic film and the adhesive is a pressure-sensitive adhesive. In further embodiments, the porous backing substrate is an apertured plastic film and the adhesive is a polyacrylate adhesive, a polyalphaolefin adhesive, a styrene-butadiene adhesive, a styrene-ethylene/butylenes adhesive, a styrene-isoprene adhesive, a polyvinyl acrylate adhesive, a natural rubber resin adhesive, a synthetic rubber resin adhesive, a silicone adhesive, a polydiorganosiloxane polyurea copolymer adhesive, a polyurethane adhesive, a urethane copolymer adhesive, or a mixture or blend of one or more such adhesives. In certain useful embodiments, the adhesive is an acrylic resin, e.g., an acrylic multipolymer. In other embodiments, the acrylic resin adhesive includes a tackifier.

In still further useful embodiments, the adhesive has sufficient internal cohesive strength that the article is removable from a substrate without separation of the backing substrate and the adhesive-carrying fabric. In particular embodiments, the article tears uniformly in the cross machine direction. In particular embodiments, the article further includes elastic yarns that are extensible in the machine direction. In other embodiments, the elastic yarns are positioned between the inner surface of the porous film and the adhesive-carrying fabric.

In another important embodiment, the article is hand-tearable. In particular embodiments, the hand-tearable article includes a porous backing substrate and an adhesive-carrying fabric applied to a surface of the backing substrate, the fabric having a porosity greater than that of the backing substrate and comprising warp yarns running in the machine direction and weft yarns running in the cross direction, the weft yarns having a higher denier than the warp yarns, and the adhesive of the adhesive-carrying fabric located on the fabric in such a manner that the fabric remains porous. In certain embodiments, the warp yarns have a denier in the range of 20 to 80, e.g., in the range of 40 to 60, or in the range of 20 to 40. In particularly useful embodiments, the warp yarns have a denier of about 30. In further embodiments, the weft yarns have a denier in the range of 50 to 200, e.g., in the range of 70 to 150. In particularly useful embodiments, the weft yarns have a denier of about 70.

In still further embodiments, the warp yarns have a density in the range of 9 yarns/inch to 24 yarns/inch, e.g., about 18 yarns/in. In certain embodiments, the weft yarns have a density in the range of 9 yarns/inch to 18 yarns/inch, e.g., about 12 yarns/inch. In particular embodiments, the tensile strength of the article in the machine direction is greater than the tensile strength in the cross direction. In particularly useful embodiments, the article is hand-tearable.

In another aspect, the invention provides an article that includes a porous film backing substrate and an adhesive-carrying fabric that is porous, and the adhesive of the adhesive-carrying fabric adheres the porous film backing substrate to the adhesive-carrying fabric. In a further aspect, the invention provides an article that has a porous film backing substrate and an adhesive-carrying fabric that is porous, and the adhesive of the adhesive-carrying fabric bonds the porous film backing substrate to the adhesive-carrying fabric such that the resulting article is porous. In yet another aspect, the invention provides an article that includes a porous film backing substrate and an adhesive-carrying fabric applied to a surface of the porous film backing substrate, the fabric having warp yarns running in the machine direction and weft yarns running in the cross direction, the weft yarns having a higher denier than the warp yarns, and the adhesive of the adhesive-carrying fabric located on the fabric in such a manner that the fabric remains porous.

In certain embodiments, the porous film backing substrate is composed of a plastic. In other embodiments, the porous film backing substrate is composed of rubber. In still other embodiments, the porous film backing substrate is composed of a polysaccharide material, e.g., cellulose. In further embodiments the polysaccharide is a synthetic polysaccharide, such as cellophane, cellulose nitrate (nitrocellulose), cellulose acetate, or cellulose acetate butyrate.

In a further aspect, the invention provides an article that includes an apertured plastic film backing substrate and an adhesive-carrying fabric that is porous, and the adhesive of the adhesive-carrying fabric bonds the porous film backing substrate to the adhesive-carrying fabric such that the resulting article is porous. In particular embodiments, the adhesive-carrying fabric is bonded to the porous film backing substrate by the adhesive and the overall article is breathable. In particularly useful embodiments, the overall article is at least about 5% open area. In still other particularly useful embodiments, the overall article is at least about 10% open area.

In another aspect of the invention, a method of making a pressure-sensitive adhesive article includes applying an adhesive in a liquid carrier to a open fabric having an open structure in such a manner that the open structure of the open fabric remains open, contacting the adhesive-coated open fabric to a porous backing substrate in a manner such that the adhesive penetrates a distance into the backing substrate, and removing the liquid carrier. A breathable pressure-sensitive adhesive article is obtained.

In another aspect, the invention provides a method of making a breathable pressure-sensitive adhesive article that includes the steps of: applying an adhesive in a liquid carrier to an open fabric having an open structure in such a manner that the open structure of the open fabric remains open; contacting the adhesive-coated open fabric to a porous backing substrate in a manner such that the adhesive-coated open fabric bonds with the porous backing substrate; and removing the liquid carrier to obtain a breathable pressure-sensitive adhesive article.

In particularly useful embodiments of the method of the invention, the porous backing substrate is an apertured plastic film. In certain embodiments, method further includes the step of corona treating the apertured plastic film prior to contacting it to the adhesive-coated open fabric. In particular embodiments, the corona treatment improves adhesion of the adhesive-coated open fabric. In further embodiments, the step of corona treating the apertured plastic film includes exposing the apertured plastic film backing to a high voltage electrical discharge. In still other embodiments, the method of the invention further includes treating the apertured plastic film prior to contacting it to the adhesive-coated open fabric, and the treatment includes the step of exposing the apertured plastic film to a gas flame, ozone, high-voltage electrical discharge or a combination these treatments.

In still further embodiments of the method of the invention, the step of applying the adhesive includes passing the adhesive-coated open fabric through a roller to remove excess adhesive. In another embodiment, the step of removing the liquid carrier of the adhesive includes heating the article, e.g., heating the article until essentially all the liquid carrier of the adhesive is removed. In yet further embodiments, the open fabric is a woven fabric, a non-woven fabric or a knit fabric. In particular embodiments, the open area of the open fabric is reduced by no more than about 50% upon coating with adhesive. In further embodiments, the open area of the open fabric is reduced by no more than about 35% upon coating with adhesive. In particular embodiments, the open area of the open fabric is reduced by about 25% upon coating with adhesive.

In yet other useful embodiments of the method of the invention, the apertured plastic film is polyethylene or a copolymer thereof. In other particular embodiments, the apertured plastic film is composed of a plastic such as polyvinyl chloride, polyproplylene, polybutylene (polybutene), polystyrene, polyurethane and polyester (e.g., Mylar), a propylene copolymer, a butylene copolymer, a vinyl chloride copolymer, a styrene copolymer, or a urethane copolymer.

In certain useful embodiments of the invention, the pressure-sensitive adhesive article is tack-free on one side to provide a soft, comfortable outer surface to the user. The open fabric is “anchored” to the other side of the backing by the adhesive so that the backing and open fabric remain intact during use. The adhesive does not block vapor and air flow through the backing because it is located on the open fabric and not between the weave of the open fabric. The pressure-sensitive adhesive tape of the present invention tears easily and evenly along the cross direction when pressure is applied at a specific point along the edge; however, the open fabric provides adequate strength in the machine direction so that it does not tear or break during normal application. Furthermore, the pressure-sensitive adhesive article provides good adhesive contact with tissue, for example, skin, yet can be easily removed without damage to the tissue.

The term “about” is used herein to mean approximately, in the region of, roughly or around. When the term “about” is used in conjunction with a numerical range, it modifies that range by extending the boundaries above and below the numerical values set forth. In general, the term “about” is used herein to modify a numerical value above and below the stated value with a variance of 10%.

### 4. BRIEF DESCRIPTION OF THE DRAWINGS

The above mentioned and other features and advantages of the present invention will become more readily apparent from the following detailed description and the accompanying drawings, in which:

FIG. 1A is an enlarged plan view of a portion of a pressure-sensitive adhesive tape according to one or more embodiments of the invention;

FIG. 1B is a cross-sectional view of the pressure-sensitive adhesive tape of FIG. 1A shown at cross-section 1B-1B;

FIG. 2 is an enlarged plan view of a portion of a pressure-sensitive adhesive tape according to one or more embodiments of the invention;

FIG. 3A is an enlarged plan view of a portion of a pressure-sensitive adhesive tape according to one or more embodiments of the invention;

FIG. 3B is a cross-sectional view of the pressure-sensitive adhesive tape of FIG. 3A shown at cross-section 3B-3B; and

FIG. 4 shows diagrammatically an apparatus and process for producing one or more embodiments of the invention, in which the adhesive-carrying open fabric is adhered to the backing substrate.

FIG. 5A is an enlarged plan view of the apertured plastic film backing portion of a pressure-sensitive adhesive tape according to one or more embodiments of the invention;

FIG. 5B is a cross-sectional view of an assemble pressure-sensitive adhesive tape of the invention, incorporating the apertured plastic film backing portion of FIG. 5A and shown in cross-section.

FIG. 6A is a graphical representation of the results of an air permeability assay comparing two different embodiments of the invention (Sample A and Sample B) with a commercially available adhesive tape;

FIG. 6B is a graphical representation of the results of an air permeability assay comparing three different embodiments of the invention (Sample C, Sample D, and Sample E) with another commercially available adhesive tape.

FIG. 7A is a graphical representation of the results of a water vapor transmission assay comparing one embodiment of the invention (Sample A) with a commercially available adhesive tape;

FIG. 7B is a graphical representation of the results of a water vapor transmission assay comparing one embodiment of the invention (Sample C) with a commercially available adhesive tape.

### 5. DETAILED DESCRIPTION OF THE INVENTION

A pressure-sensitive adhesive article includes a porous backing having an adhesive-carrying open fabric adhered thereto. The open fabric is of an open weave or knit and the adhesive is located only on the fabric yarns, threads or fibers in such a manner that the adhesive-carrying fabric remains substantially open and air permeable in the assembled article. In this way, the porosity of the backing is maintained so that a breathable article having high vapor permeability is obtained.

In some embodiments, the assembled air permeable adhesive article has an overall air permeability of at least about 100 ft³/minute. In still other embodiments, the overall air permeability is at least about 125 ft³/minute, usefully at least about 150 ft³/minute and, most usefully, at least about 200 ft³/minute. In further embodiments, the permeable adhesive article is assembled for an open weave fabric that is at least about 25% open area between applications of the adhesive. In other embodiments, the open weave fabric of the adhesive carrying fabric layer is at least about 30% open area, usefully at least about 40% open area, and, most usefully, at least about 50% open area between applications of the adhesive. In still further embodiments, the adhesive-carrying fabric layer has an overall open area, in the assembled article, of at least about 15% of the surface are of the assembled article. In still other embodiments, the adhesive-carrying fabric layer has an overall open area of at least about 20%, usefully at least about 25%, and most usefully, at least about 30% of the surface area of the assembled article.

In particularly useful embodiments, the porous backing substrate is a porous film, especially a porous plastic film such as an apertured plastic film. In particularly useful embodiments, the porous backing substrate is at least about 20% open area, usefully at least about 24% open area.

In other embodiments, the adhesive penetrates a distance into the backing substrate to anchor the open fabric to the backing. In some other embodiments, the open layer has yarns of unequal tensile strength in the cross and machine directions and thereby imparts different tear characteristics to the article in the machine direction (MD) and cross direction (CD). The open fabric provides sufficient strength to the article in the machine direction so that the tape does not fail during use; however, the strength of the tape in the cross direction permits an even and easy tear. In one or more embodiments, the tape is hand tearable. In still other embodiments, the pressure-sensitive adhesive article exhibits two or more of these features.

By “open structure” it is meant that the weave includes areas that are open or free of yarn or fibers (and adhesive). The open structure can include pores such as are typically found in non-woven fabrics, or it can be a much larger open structure such as a scrim or mesh. The openness of a structure is defined, for example, by pore size, thread count and/or % open area.

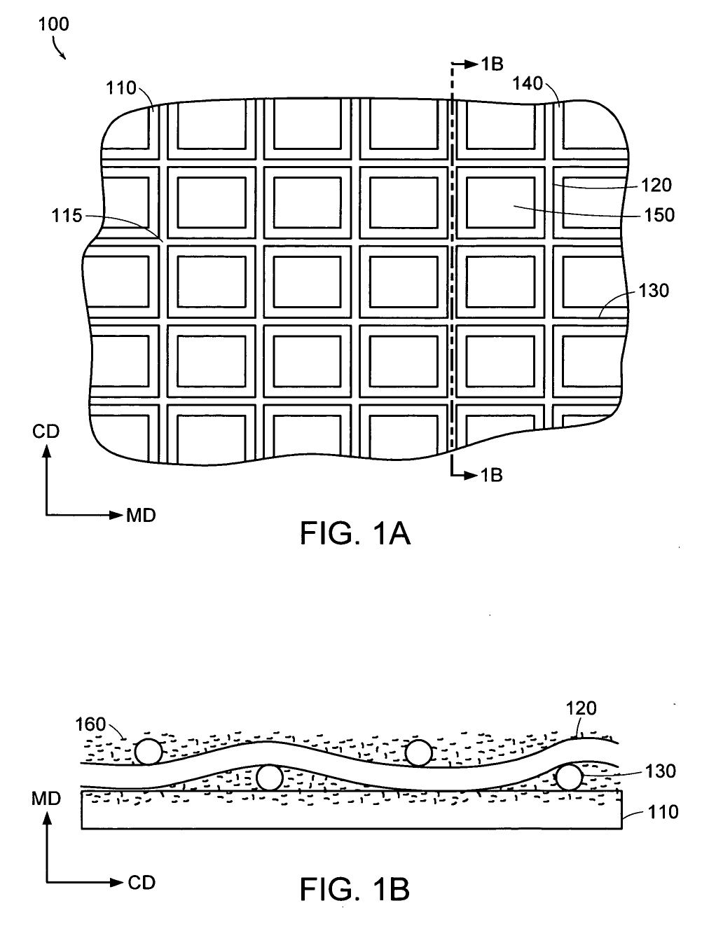

FIG. 1A illustrates a pressure-sensitive adhesive article 100 according to some embodiments of the present invention. The article includes a porous backing 110 onto which an open fabric 115 is adhered. The open fabric 115 carries an adhesive 140 so that the open spaces 150 of the fabric are substantially free of adhesive and the porosity of the fabric is substantially unchanged. Adhesive 140 penetrates a distance into the porous backing 110 to secure the fabric 115 on one side of the porous backing. The open fabric 115 can be made up of CD yarns 120 and MD yarns 130 that reinforce and strengthen the pressure-sensitive adhesive article. FIG. 1B provides a cross-sectional view of the pressure-sensitive adhesive article across line 1-1′ of FIG. 1A. The adhesive 140 (shown as dotted matrix 160 in FIG. 1B) surrounds and permeates the CD yarns 120 and MD yarns 130 of open fabric 115. The adhesive matrix 160 also penetrates a distance into the backing 110. Note that the adhesive does not penetrate the full thickness of backing 110.

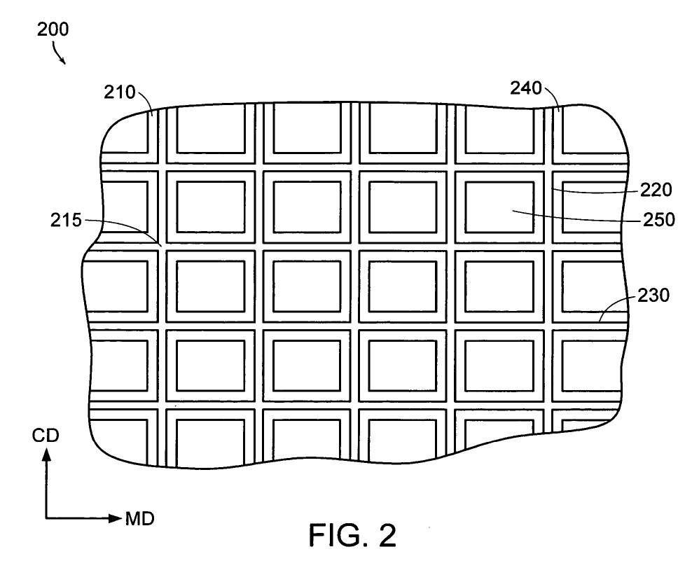

FIG. 2 illustrates a pressure-sensitive adhesive article 200 according to one or more embodiments of the present invention in which the tensile strength of the CD and the MD yarns differs. The article includes a porous backing 210 onto which an open fabric 215 is adhered. As in the previous embodiment, the open fabric 215 carries an adhesive 240 so that the open spaces 250 of the fabric are substantially free of adhesive and the porosity of the fabric 215 is substantially unchanged. The open fabric 215 can be made up of CD yarns 220 and MD yarns 230 that reinforce and strengthen the pressure-sensitive adhesive article. CD yarns 220 can have a greater tensile strength than the MD yarns 230.

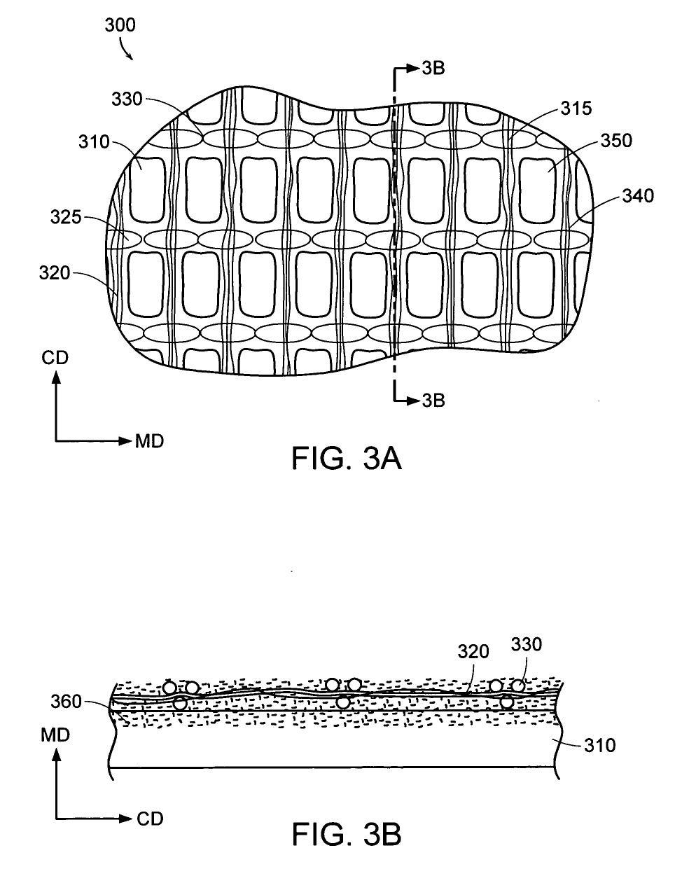

FIG. 3A illustrates yet another pressure-sensitive adhesive article 300 according to one or more embodiments of the invention in which an open knit fabric 315 is used. As in the article of FIG. 1A, the article includes a porous backing 310 onto which is adhered the open fabric 315. The open fabric 315 carries an adhesive 340 so that the open spaces 350 of the fabric are substantially free of adhesive and the porosity of the fabric is substantially unchanged. The open fabric 315 is made up of warp-knit (MD) yarns 330 having a weft (CD) yarn 320 inserted through a knit loop 325 of the warp knit yarn 330. The weft inserted yarns may include one or more filaments, the number and size of which are selected to have a desired tensile strength. By way of example only, the weft yarns are shown having three filaments; however, the weft yarns may be monofilament or multifilament. The weft yarns can have a number of filaments, for example, 3-15 filaments. FIG. 3B provides a cross-sectional view of the pressure-sensitive adhesive article across line 3-3′ of FIG. 3A. The adhesive 340 (shown as dotted matrix 360 in FIG. 3B) is shown surrounding and permeating the weft insert yarns 320 and warp knit yarns 330 of open fabric 315. The adhesive matrix 360 also penetrates a distance into the backing 310. Note that the adhesive does not penetrate the full thickness of backing 310.

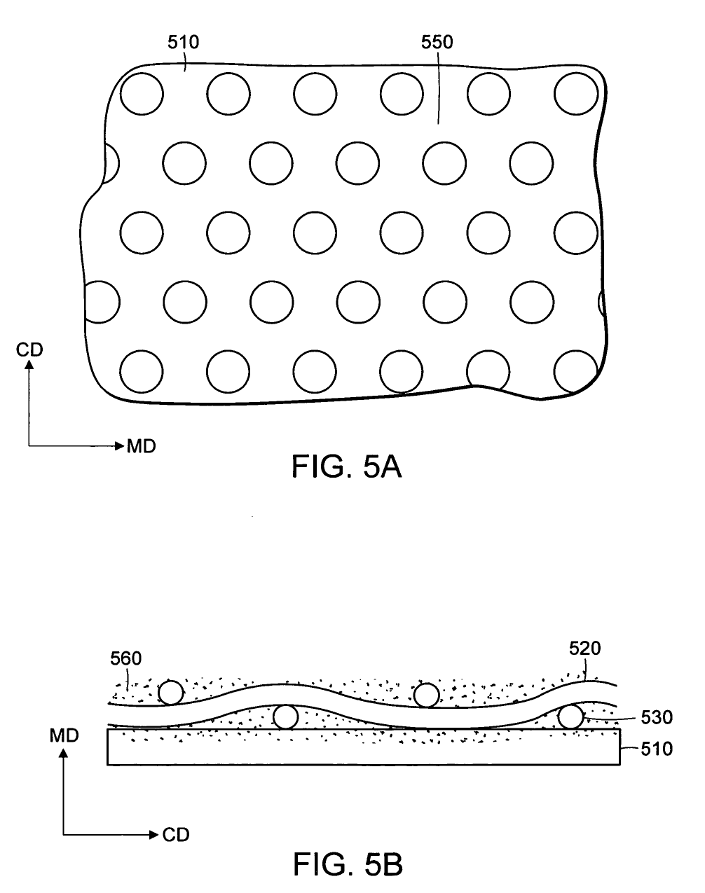

FIG. 5A illustrates an apertured plastic film 510 having circular openings 550 for use as a porous backing substrate in some embodiments of the pressure-sensitive adhesive articles of the invention. The circular openings make up about 24% of the surface area of the film in the embodiment depicted. FIG. 5B illustrates an assembled article incorporating an apertured plastic film 510 porous backing substrate. As is FIG. 1A, the article also includes an open fabric, made up of weft (CD) yarns 520 and warp (MD) yarns 530, that carries an adhesive (shown as dotted matrix 560 in FIG. 5B) so that the open spaces of the fabric are substantially free of adhesive such that the fabric remains porous.

The backing substrate is any conventional porous backing and can be a woven, knit or non-woven fabric. The backing fabric is not required to be of high tensile strength because the open fabric provides tensile strength in both the cross and machine directions. The porosity of the backing substrate is sufficient to provide a breathable, water vapor permeable membrane in the assembled pressure-sensitive tape. The backing substrate can be more than about 25% open area, and more than about 50% open area in some embodiments.

In a non-woven substrate backing, the fibers are intimately entangled with each other to form a coherent, breathable fibrous non-woven backing. The particular fiber composition used as a non-woven backing substrate is selected from those known in the prior art, according to the web property desired. For example, the non-woven substrate backing may be selected from the naturally occurring animal and vegetable fibers, including cotton and wool, or synthetic (chemical) fibers such as nylons, cellulosics, rayon, polyesters, polyamides, acrylics, polypropylene, polyethylene, and the like, including blends of such fibers. In one or more embodiments, the nonwoven fabric is lightweight and can typically be about 10-20 grams per square meter.

The non-woven substrate backing can further include a bonding agent or sizer to lock adjacent fibers of the non-woven fabric. The bonding agent promotes adhesion of the pressure-sensitive adhesive to individual yarns or fibers of the substrate backing when the pressure-sensitive adhesive and the backing are combined. Suitable bonding agents are selected from those known in the art, and can include, by way of example, homopolymers and copolymers of synthetic latexes such as butadiene, acrylics, vinyls and the like. The bonding agent is applied from a liquid carrier or solution at low solids levels so that the porosity of the non-woven is not impaired. The manner of applying the binding agent to the non-woven web is non-critical and any of the known methods of the coating art may be employed. Commercially available bonded non-woven fabrics can also be used in the articles of the present invention.

Woven or knit fabrics can also be used as a backing substrate and are selected from those known in the prior art. Exemplary fabrics include woven cotton fabrics, woven rayon, polyester or polypropylene fabrics and knit fabrics such as polyester, polypropylene and nylon knit fabrics.

The porous backing substrate may also be a porous film, such as an apertured plastic film. As used herein, the term “film” refers to a flat material that is extremely thin in comparison to its other dimensions and has a nominal maximum thickness of about 300 micrometers and a lower limit of thickness of about 10 micrometers. As used herein the term “porous” refers to the property of having pores through which liquids and/or gases may pass.

Porous films of the invention may be composed of any suitable material capable of existing as a self-supporting film having pores through which liquids and/or gases may pass. Suitable materials include, but are not limited to, plastics (e.g. polyolefins, such as polyethylene, polypropylene, polybutylene (polybutene) and/or copolymers of ethylene, propylene or butylene), rubbers (e.g., natural or synthetic rubbers), and natural or synthetic polysaccharide films (e.g., cellulose, nitrocellulose, or cellulose acetate). Porous plastic film backings include, generally, those composed of polyolefins, such as polyethylene, including high density polyethylene, low density polyethylene, linear low density polyethylene, and linear ultra low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; polyurethanes; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used.

In certain instances, the adhesion of the porous plastic backing substrate to the adhesive-carrying fabric layer may be facilitated by corona treatment of the backing material. Corona treatment is a common method used to increase the surface energy of plastic by means of a high voltage electrical discharge, thus improving its wettability and adhesion characteristics for printing and laminating. There are numerous theories explaining the principles behind the process of corona treating. While not wishing to be bound by any one particular theory of operability, the most commonly accepted theory behind corona treatment appears to be the theory of high speed oxidation. Basically, this theory states that the energy of the corona breaks the molecular bonds on the surface of the non-polar substrate. The broken bonds then recombine with the free radicals in the corona environment to form additional polar groups on the film surface. These polar groups have a strong chemical affinity to the polar inks and adhesives, which results in improved adhesion. Similarly, the polar surface results in an increased surface energy which correlates with improved wettability.

The porous fabrics for use in the adhesive-carrying fabric layer of the articles of the invention have an open structure and can be a woven or knit fabric. The openness of the fabric (which is a function of, for example, thread count and yarn denier) is selected so that the assembled structure, e.g., backing substrate, adhesive, and open fabric, is porous and vapor permeable. It is also selected to provide sufficient adhesive surface area to establish a strong adhesive contact with the backing substrate. The fabric can be up to about 95% open, i.e., 5% of surface area of the article is porous fabric, and is typically at least about 50% open. By way of example only, the open fabric can be an open weave fabric such as gauze, e.g., cotton or synthetic polymer gauze, or a warp-knit fabric.

In some embodiments, the open fabric exhibits a tensile strength differential in the machine and cross directions of the fabric. In order to provide warp and weft yarns of different tensile strength, yarns of different denier can be used. Denier is a unit of fineness for yarns, based upon 50 milligrams per 450 meters of yarn (1 denier). For fabrics using warp and weft yarns of the same or different material, differences in tensile strength can be achieved by using yarns of different denier, e.g., a “thin” yarn and a “thick” yarn. By way of example, warp yarns in the range of 20 to 80, 40 to 60 or 20 to 40 denier may be used. In certain embodiments, warp yarns of a denier of about 30 are used. Further by the way of example, weft yarns in the range of 50 to 200, particularly those in the range of 70 to 150 are used. In particular embodiments, weft yarns of a denier of about 70 are used. In other embodiments, different warp and weft strengths are achieved by using yarns of different filament counts. By way of example only, a low denier monofilament is used as a warp yarn and a high denier multifilament yarn is used as the weft yarn.

In one or more embodiments, a knitted fabric can be used, in which the yarns are formed into stitches in a lengthwise (machine) direction and a weft (cross machine) insert yarn of same or different strength is inserted through the warp stitches to provide a fabric having the same or differing tensile strengths in the warp and weft directions. In some embodiments, the warp knit/weft insertion fabric has a weight of less than about 50 grams per square meter (about 1.5 oz. per square yard) or about 25-30 grams per square meter (about 0.7-0.9 oz. per square yard), and may be as low as 5 grams per square meter. An exemplary warp knit/weft insertion fabric has a weight ranging from about 25 to about 10 grams per square meter, and a warp/weft thread count ranging from about 18×12 to about 9×12. The knitted warp yarns are about 40 denier polyester, and the about 150 denier fill or weft yarns are loose, nontwisted, texturized polyester filaments. Similar warp knit/weft insertion fabrics are available commercially, e.g., warp knit/weft insertion greige fabric is available from Milliken & Company of Spartenburg, S.C. A warp knit/weft insertion construction provides a lightweight fabric having high tensile strength, e.g. about 12-13 lb/in², in the warp direction.

In one or more embodiments, the open fabric is characterized by a warp yarn(s) of lower tensile strength than the weft yarn(s). The difference in tensile strength gives rise to different tear characteristics in the cross or machine directions; and the arrangement of the weave provides a clean, even tear along the CD. The low stretch characteristics of the MD yarns tend to focus the load at the point of tear and cause the yarns to fail in a predictable manner. The stronger CD yarns tend to guide the tear and cause the tear to propagate between the CD yarns. The CD yarns also promote a straight tear across the structure and cause the fibers (of the nonwoven backing substrate) to break cleanly without a ragged, uneven edge.

Accordingly, in some embodiments of the present invention, the adhesive carrying fabric layer may be a scrim woven fabric having warp yarns, which generally run in the machine direction (MD), and weft yarns, which generally run in the cross direction (CD). The warp yarns and weft yarns of the adhesive-carrying fabric may be yarns of any suitable material. For example, the warp yarns and weft yarns may be yarns of polyolefin, polyester, polycotton, cotton, or any other suitable material that allows for hand-tearing of the assembled article while providing the desired tensile strength. The weft yarns extending transversely of the tape may be, for example, texturized filament yarns.

As described above, while the fabric of the adhesive-carrying fabric layer is generally characterized by a warp yarn(s) of lower tensile strength than the weft yarn(s) so as to facilitate hand tear, the relative strengths of the overall article in the machine direction versus the cross direction is also influenced by the density of the warp and weft yarns. Accordingly, the overall strength of the article in the machine direction may be higher than that in the cross direction, despite the fact that a weft yarn having a higher denier than that of the warp yarn is utilized.

Accordingly, the warp yarns may be spaced at a density in the range of 9 to 24 yarns per inch as measured transversely of the assembled article. In particular embodiments, the warp yarns may be spaced at a density of about 18 yarns per inch. Alternatively, the warp yarns may be spaced at a density in the range of 12 to 18 yarns per inch, 18 to 30 yarns per inch, or any other suitable range of densities. Further, the warp yarns may have a denier in the range of 20 to 80. In some embodiments, the warp yarns may have a denier in the range of 40 to 60. Alternatively, the warp yarns may have a denier in the range of 20 to 60, 40 to 80, 60 to 100, or any other suitable range of deniers. In particular embodiments, the warp yarns may have a denier of about 30.

The weft yarns of the adhesive-carrying fabric layer be spaced at a density in the range of 9 to 18 yarns per inch as measured longitudinally of the assembled article. In particular embodiments, the weft yarns may be spaced at a density of about 12 yarns per inch. In some embodiments, the weft yarns may be spaced at a density in the range of 6 to 24 yarns per inch as measured longitudinally of the tape or other assembled article. Alternatively, the weft yarns may be spaced at a density in the range of 12 to 24 yarns per inch, 18 to 36 yarns per inch, 30 to 48 yarns per inch, or any other suitable range of densities. Further, the weft yarns may have a denier in the range of 50 to 200. In some embodiments, the weft yarns may have a denier in the range of 70 to 150. In particular embodiments, the weft yarns may have a density of about 12 yarns per inch. Alternatively, the weft yarns may have a denier in the range of 40 to 170, 170 to 300, or any other suitable range of deniers.

In some embodiments, the pressure-sensitive adhesive tape can include elastic yarns, resulting in a self-wound pressure-sensitive tape having a degree of stretch (elongation) ranging from approximately 30% to 150%. The backing substrate and the open fabric can have substantially the same elasticity and extensibility.

A pressure-sensitive polymer is applied to the open fabric. Pressure-sensitive adhesives adhere to most surfaces with very slight pressure and they retain their tackiness. Pressure-sensitive adhesives include a large group of adhesives that utilize many different polymers (acrylics, rubbers, polyurethanes), together with plasticisers and tackifying resins to form a permanently tacky (sticky) adhesive. The name “pressure-sensitive” comes from the fact that moderate pressure alone is sufficient to spread the viscous adhesive layer on to the surface to be adhered to and achieve useful adhesive strength. They are available in both solvent and latex or water based forms. Pressure sensitive adhesives are often based on non-crosslinked rubber adhesives, acrylics or polyurethanes. They form viscoelastic bonds that are aggressively and permanently tacky, and adhere without the need of more than finger or hand pressure.

Any pressure sensitive adhesive is useful for preparing the articles of the invention. Pressure-sensitive adhesives generally include elastomers that are inherently tacky or elastomers or thermoplastic elastomers that include tackifying resins and plasticizing additives. Fillers, antioxidants, stabilizers and crosslinking agents known in the art also may be used. A fluid, typically water, is added to reduce the viscosity to a level that is easily applied to the open fabric. The amounts and kinds of ingredients of the pressure-sensitive adhesive are selected to provide appropriate substrate adhesion and target peel strength. Strong substrate adhesion and a moderate peel strength are desired for use with living skin. Suitable pressure-sensitive adhesives include polyacrylate adhesives, polyalphaolefin adhesives, such as linear, radial, branched and tapered block copolymers including styrene-butadiene, styrene-ethylene/butylenes and styrene-isoprene block copolymers, polyvinyl acrylates, natural and synthetic rubber resin adhesives, silicones, polydiorganosiloxane polyurea copolymers, and mixture and blends thereof. Many suitable pressure-sensitive adhesives are known in the art and may be utilized with the subject invention. Particularly useful pressure-sensitive adhesives for use in the invention include acrylic resins (e.g., Gelva™ Multipolymer Solution 2495; Cytec Surface Specialties; Indian Orchard, Mass.).

The adhesive is located at least on upper and lower surfaces of the open fabric. It covers the upper and lower surfaces without spanning adjacent yarns, so that porosity or openness is retained. In some embodiments, the adhesive is suffused or permeated throughout the entire thickness of the open fabric. The pressure-sensitive adhesive is selected to be removable from the skin without separation of the substrate backing from the open fabric.

The adhesive-coated open fabric adheres to the backing substrate by adhesive contact. Adhesion of the open fabric to the substrate is enhanced by partial penetration of the adhesive into a portion of the thickness of the backing substrate. Adhesive is absorbed by the backing only in those areas where the open fabric contacts the substrate. The open areas of the open fabric are substantially free of adhesive, so that no adhesive is transferred to the backing substrate in these areas. The adhesive does not saturate the full thickness of the backing, so that the side of the backing substrate opposite the open fabric is essentially free of adhesive. The two different tape surfaces make the pressure-sensitive tape self-winding and permit an even unwind of the tape from a roll. The adhesive can penetrate up to about 95% of the thickness of the backing substrate, and in some embodiments, the adhesive penetrates into about 25% to about 75% of the backing thickness. Typically, the adhesive penetrates about 50% of the backing thickness.

Because the adhesive-carrying open fabric retains its openness, the vapor permeability of the article remains high. Microporosity and water vapor permeability can be measured in a variety of ways, for example, by measuring the amount of air expressed in mL/min by a known surface at a certain pressure. Pressure-sensitive adhesive tapes desirably maintain a maximum water vapor transmission rate. An exemplary tape prepared according to one or more embodiments of the invention had a water vapor transmission (WVT) of 28 grains/ft²-h (water method) (ASTM: E96-00^{ε}^{₁}), which represents at least about a 25% improvement over current industry standards.

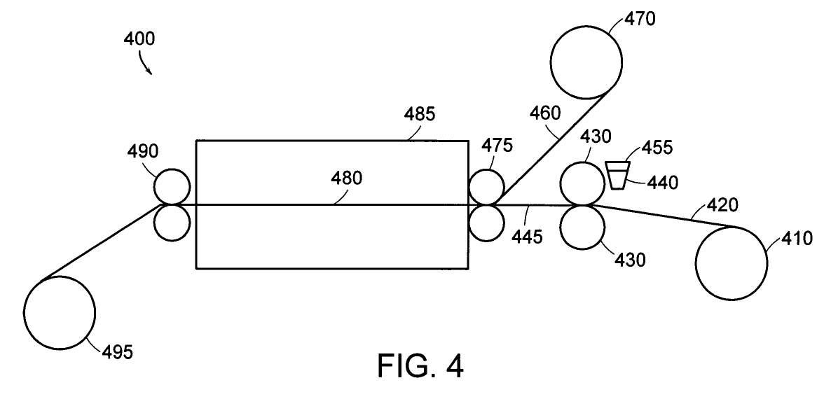

An apparatus 400 for preparing the pressure-sensitive adhesive coatings of the invention is shown schematically in FIG. 4. The apparatus 400 includes a feed roll 410 for supplying an open fabric 420.

The open fabric 420 is guided into nip rolls 430 that supply a metered amount of an adhesive 440 to the fabric from reservoir 455. The adhesive composition includes an adhesive and a carrier liquid, preferably water. The adhesive composition is of a solids content and viscosity that permits impregnation and coating of the yarns of the open fabric, yet avoids spanning of the adhesive across adjacent yarns. Although the actual composition may vary depending upon the particular adhesive and open fabric used, typical adhesive solutions contain about 20-50 wt % adhesive solids. Additives, e.g., antifoaming agent, can be added to improve the machinability of the adhesive. The coating process applies sufficient adhesive to saturate the fibers of the fabric but not to form a continuous adhesive coating. Thus, the porosity of the open fabric is substantially unaffected by adhesive application. The open area of the fabric is reduced by no more than about 20%, or even no more than about 10%. By way of example, an open fabric that initially contains about 90% open area is reduced to about 80% open area upon coating with adhesive.

The adhesive-coated fabric 445 next is transported to nip rolls 475. A backing substrate 460 is fed from feed roll 470 and is contacted to the surface of the adhesive-coated fabric 445 at nip 475 to form a laminate structure 480. The adhesive is sufficiently viscous such that the adhesive does not bleed through the entire thickness of the backing substrate 460; however, the adhesive is able nonetheless to penetrate the backing substrate 460 to anchor the open fabric 445. The laminate structure 480 then is passed through heater 485 and at least one roller 490 to dry the laminate structure 480 and to secure the open fabric to the backing. The heater can be heated air, heat lamps, or any other conventional source of heat. Essentially all of the carrier liquid is removed in the drying step. The finished product then is wound onto take-up roll 495.

The foregoing detailed description includes many specific details. The inclusion of such detail is for the purpose of illustration only and should be understood not to limit the invention. In addition, features in one embodiment may be combined with features in other embodiments of the invention.

### 5. EXAMPLES

This invention is further illustrated by the following examples, which should not be construed as limiting. In these illustrative examples, an open-weave non-woven fabric backing or an apertured plastic film backing substrate is bonded to an adhesive-carrying open fabric and the resulting adhesive article is tested to show that it is porous and highly breathable as measured by both standard air permeability and water vapor transmission rate (WVTR) assays.

Production of a Porous Pressure-Sensitive Adhesive Tape with an Apertured Film Backing

A solvent-based acrylic resin solution (Gelva™ Multipolymer Solution 2495; Cytec Surface Specialties; Indian Orchard, Mass.) having solvent components (parts by weight) ethyl acetate (51%), ethanol (25%) and toluene (24%) was applied to an open weave fabric having warp yarns (MD) of approximately 30 denier spaced at a density of approximately 18 yarns/inch, and weft yarns (CD) of approximately 70 denier spaced at a density of about 12 yarns/inch (Milliken & Company, Spartanburg S.C.). The solvent-based acrylic resin solution is a self-curing resin having approximately 44-46% total solids and a viscosity of about 1,600-2,400 cps. (@ 25° C.; LVF #3 @ 30 rpm). This resin solution dries quickly at room temperature to produce a permanently tacky film of pressure sensitive adhesive. The degree of cure using this adhesive is independent of drying conditions. The performance properties of the acrylic pressure sensitive adhesive are reflected by a 180° peel strength of 3.5 lbs./in. width when 1 mil dry adhesive is used to bond 1 mil polyester film to stainless steel and allowed to dry for 20 minutes, a 180° peel strength of 6.2 lbs./in. width when 1 mil dry adhesive is used to bond 1 mil polyester film to a stainless steel surface and allowed to dry for 24 hours, a shear resistance at 1 lb/0.25 sq. in. of 7 hrs; and a polyken tack of 475 grams.

Sufficient solvent based acrylic resin solution is applied to the open weave fabric to produce an adhesive-carrying open fabric which, when applied to a porous backing substrate and allowed to dry, results in a dried article having approximately 50% of weave openings closed by the dried adhesive and the remaining approximately 50% of weave openings left open. The amount of solvent based acrylic resin added to the open weave fabric can be adjusted by the rate of delivery of the solution to the fabric, by the amount of pressure applied by the machine nip rolls (430 and or 475, FIG. 4), or by other means available in the art, so as to achieve this value of approximately 50% open weave openings in the finished article. The pattern of open weave openings in the finished article is relatively random.

A porous polyethylene apertured film having a basis weight of about 24.7 g/m² and a percent open area of about 24% (Pliant Corporation Cat. No. XP9415B; Schaumburg, Ill.) is contacted to the surface of this adhesive-coated fabric. The article is allowed to dry and the resulting porous, pressure sensitive adhesive article has a net percent open area of approximately 10-12%, which is roughly equal to the arithmetic product of the 24% open area of the apertured film backing substrate and the 50% open weave openings of the dried adhesive-carrying fabric.

Air Permeability Test of the Porous Pressure-Sensitive Adhesive Tapes

To see if desirable, if not superior breathability characteristics were achieved in representative pressure-sensitive adhesive tapes of the invention, standardized tests were performed and the properties of the new tapes were compared to various commercially available pressure-sensitive adhesive tapes.

One test of breathability is to measure the air permeability of the tape. Air permeability is the rate of air flow passing perpendicularly through a known area under a prescribed air pressure differential between the two surfaces of a material. A standard test method for measuring the air permeability of textile fabrics is described by the American Society for Testing and Materials (ASTM) (see Testing Procedure Designation: D 737-96). Briefly, the test is used to measure the air permeability of fabric at a stated pressure differential between two surfaces of the fabric, which is generally expressed in SI units as cm³/s/cm² and in inch-pound units as or ft³/min/ft² calculated at operating conditions. The rate of air flow passing perpendicularly through a known area of fabric is adjusted to obtain a prescribed air pressure differential between the two fabric surfaces. From this rate of air flow, the air permeability of the fabric is determined.

Two breathable tapes according to the instant invention, Sample A and Sample B, were tested for air permeability and compared to another tape with comparable adhesive properties, Micropore™ brand surgical tape from 3M (St. Paul, Minn.). Sample A and Sample B are each constructed with 20 GSM (gram square meter) spun-bond non-woven fabric backings each having slightly different porosities.

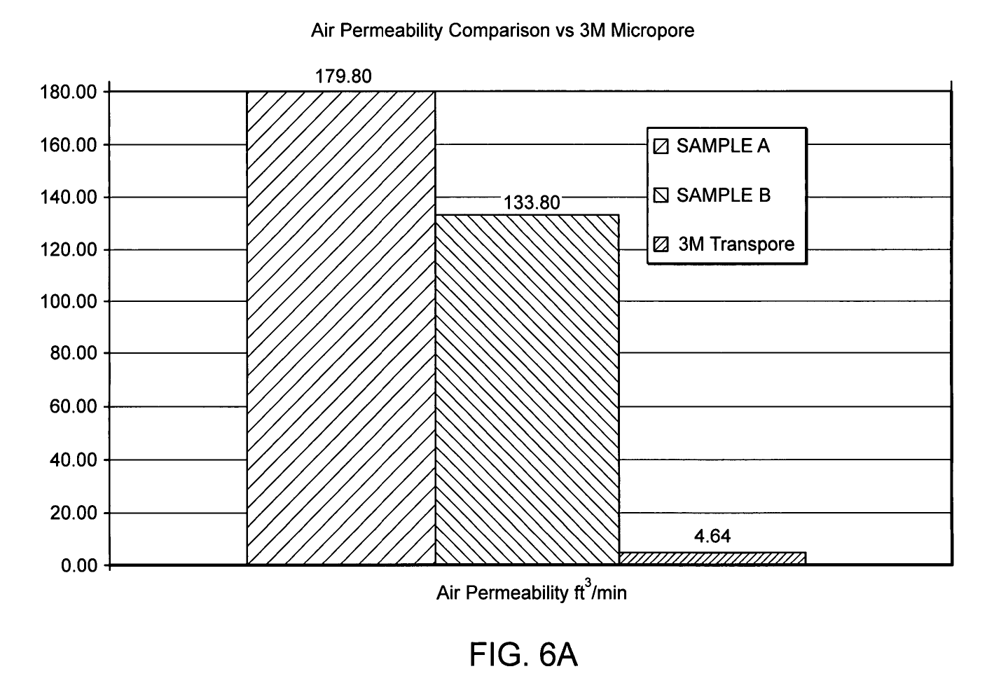

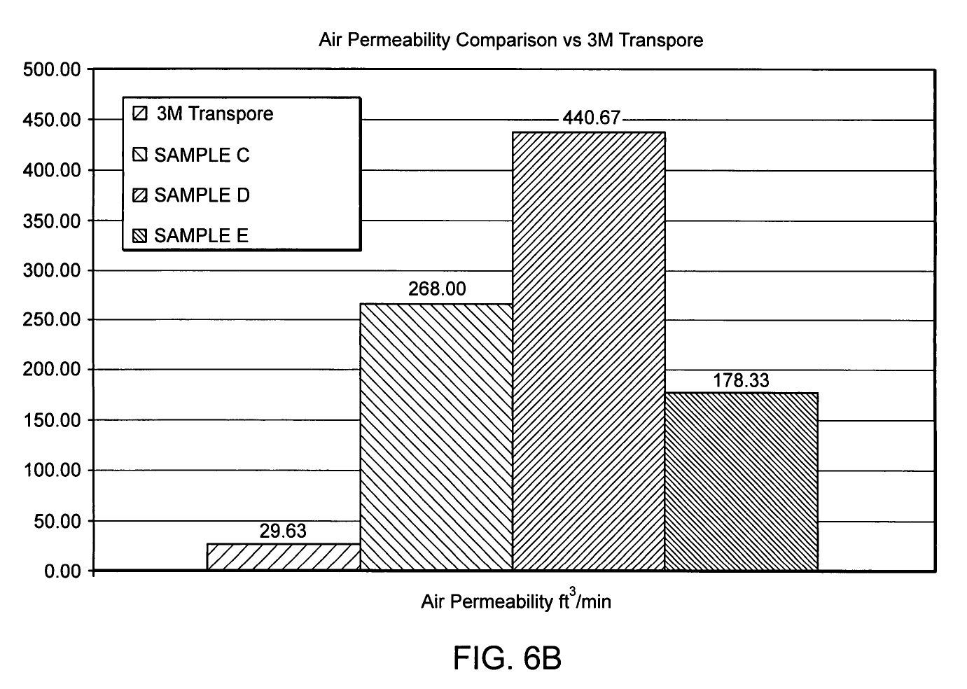

The results are shown in FIG. 6A, which demonstrates that Sample A is roughly 38 times more air permeable (air permeability 179.80 ft³/min), and Sample B is roughly 28 times more air permeable (air permeability 133.80 ft³/min) than the 3M Micropore™ surgical tape. By way of comparison, the ASTM reports (see report designation D 737-96) that a typical untreated spun yarn, plain weave fabric (material 6-S/0002H), has an average air permeability of 215 ft³/min/ft². Therefore these exemplary tapes provide a degree of breathability that is superior to a commercially available surgical tape having comparable adhesive properties. Indeed, these exemplary tapes provided a degree of breathability comparable to that of an open fabric unobstructed by an adhesive coating.

Two other breathable tapes were constructed having apertured film plastic backings—Sample C having a 30 GSM polyethylene backing film with 26% open area and diamond-shaped apertures, and Sample D having a 30 GSM polyethylene backing film with 22% open area and football-shaped apertures. These tapes were constructed using the solvent-based acrylic resin solution (Gelva™ Multipolymer Solution 2495; Cytec Surface Specialties; Indian Orchard, Mass.), described above, and an open weave fabric having warp yarns (MD) of approximately 30 denier spaced at a density of approximately 18 yarns/inch, and weft yarns (CD) of approximately 70 denier spaced at a density of about 12 yarns/inch (Milliken & Company, Spartanburg S.C.). In addition; another breathable tape of the invention, EX2899, which utilizes a Pliant 1.14 mil porous polyethylene apertured film backing having a basis weight of about 24.7 GSM and a percent open area of about 24% (Pliant Corporation Cat. No. XP9415B; Schaumburg, Ill.) was constructed.

These breathable tapes were tested for air permeability and compared to another commercially available transparent, perforated plastic tape with similar adhesive properties (i.e., 3M™'s Transpore™ adhesive surgical tape). The results are shown in FIG. 6B, which demonstrates that Sample D, constructed with an apertured film with football shaped apertures and a 22% open area, is roughly 16 times more air permeable (air permeability 440.67 ft³/min), and Sample C, constructed with an apertured film with diamond shaped apertures and a 26% open area, is roughly 10 times more air permeable (air permeability 268.00 ft³/min) than the 3M Transpore™ tape (air permeability 26.93 ft³/min). In addition, the EX2899 tape, constructed with an apertured film with circle shaped apertures and a 24% open area, is more than 6 times more air permeable (air permeability 178.33 ft³/min) than the 3M Transpore™ tape. These results show that the tapes of the invention are much more air permeable than other surgical tapes having comparable adhesive properties. Furthermore, these results demonstrate that, for the adhesive tapes of the invention, the characteristics of the plastic film backing can be manipulated so as to achieve the desired porosity and breathability.

Water Vapor Transfer Test of the Porous Pressure-Sensitive Adhesive Tapes

Another test of breathability is to measure the water vapor transmission rate of the tape. Water vapor transmission rate is the steady water vapor flow in unit time through unit area of a body, under specified temperature and humidity conditions. A standard test method for measuring the water vapor transmission of textile fabrics is the so-called water method described by the American Society for Testing and Materials (ASTM) (see Testing Procedure Designation: E 96-00). Briefly, in the water method test, the test specimen is sealed to the open mouth of a test dish containing distilled water, and the assembly is placed in a controlled atmosphere. The assembly is then periodically weighed to determine the rate of vapor movement through the specimen from the water to the controlled atmosphere. The rate of water vapor transmission is generally expressed in units of grams of water transmitted per unit time through unit area of material (e.g., g/day-m²).

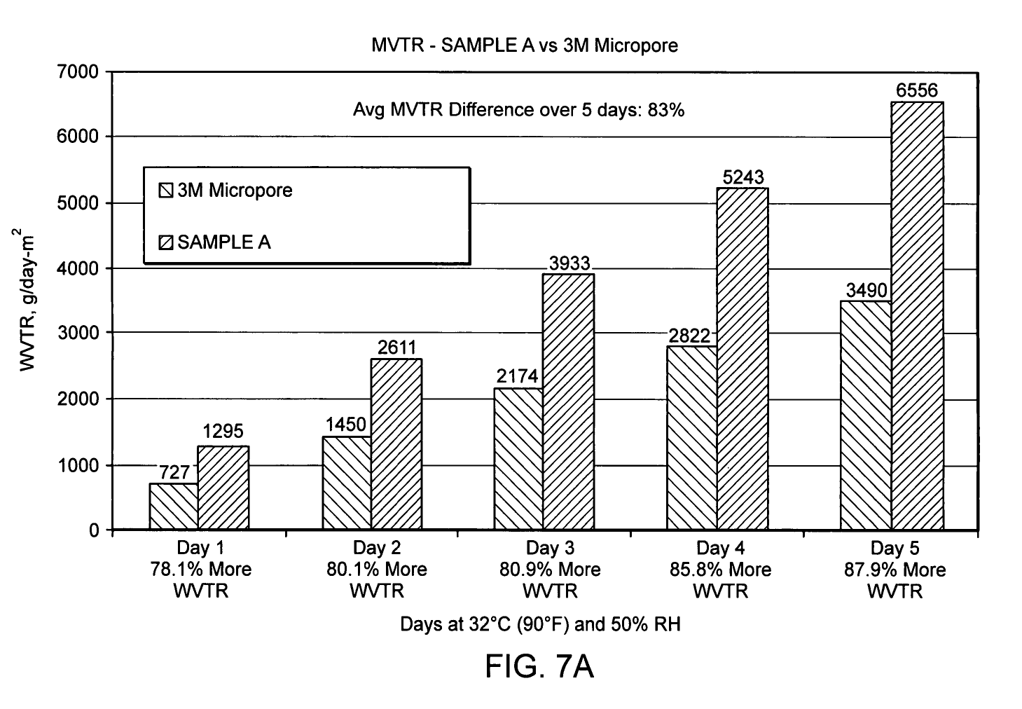

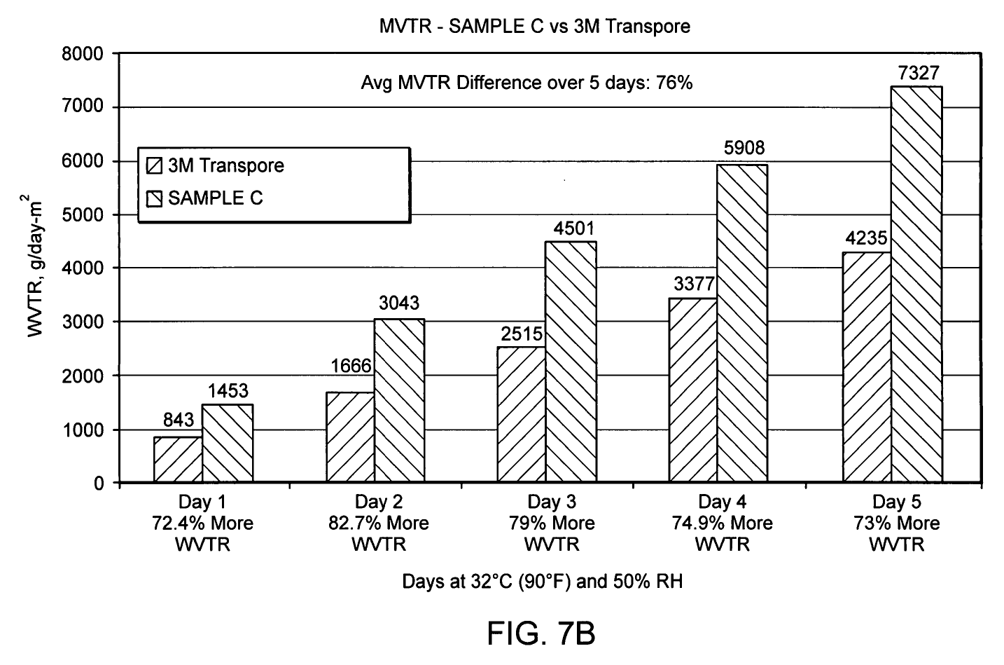

The results of the water vapor transmission tests are shown in FIGS. 7A and 7B. As shown in FIG. 7A, the EX2895—Sized PillowBond C123 had on average, over a five day testing period, about an 82% higher rate of water vapor transfer than did the 3M Micropore™ surgical tape. Similarly, as shown in FIG. 7B, EX2892-PCI #6023A Film had on average, over a five day testing period, about a 76% higher rate of water vapor transfer than did the 3M Transpore™ surgical tape.

These results demonstrate that a critical property affecting skin maceration and associated irritation and loss of adhesive properties, i.e., water vapor transfer rate, is significantly improved in the tapes of the instant invention over comparable commercially available tapes that are currently available.

Those skilled in the art will recognize, or be able to ascertain, using no more than routine experimentation, numerous equivalents to the specific substances and procedures described herein. Such equivalents are intended to be encompassed in the scope of the claims that follow.

1. An air permeable adhesive article comprising:
a porous backing substrate; and
an adhesive-carrying fabric applied to a surface of the backing substrate, the fabric having a porosity greater than that of the backing substrate and the adhesive of the adhesive-carrying fabric being located on the fabric in such a manner that the air permeable adhesive article has an overall air permeability of at least about 100 ft³/minute.

2. The air permeable adhesive article of claim 1, wherein the overall air permeability is at least about 125 ft³/minute.

3. The air permeable adhesive article of claim 1, wherein the overall air permeability is at least about 150 ft³/minute.

4. The air permeable adhesive article of claim 1, wherein the overall air permeability is at least about 200 ft³/minute.

5. An air permeable adhesive article comprising:
a porous backing substrate having at least about 20% open area; and
an adhesive-carrying fabric applied to a surface of the backing substrate, the fabric of the adhesive-carrying fabric having at least about 25% open area before application of the adhesive.

6. The air permeable adhesive article of claim 5, wherein the fabric of the adhesive-carrying fabric layer has at least about 30% open area before application of the adhesive.

7. The air permeable adhesive article of claim 5, wherein the fabric of the adhesive-carrying fabric layer has at least about 40% open area before application of the adhesive.

8. The air permeable adhesive article of claim 5, wherein the fabric of the adhesive-carrying fabric layer has at least about 50% open area before application of the adhesive.

9. An air permeable adhesive article comprising:
a porous backing substrate having at least about 20% open area; and
an adhesive-carrying fabric applied to a surface of the backing substrate, the fabric having a porosity before application of the adhesive that is greater than that of the backing substrate, and the adhesive-carrying carrying fabric layer having an overall open area of at least about 15% of the surface area of the assembled article.

10. The air permeable adhesive article of claim 9, wherein the adhesive-carrying carrying fabric layer having an overall open area of at least about 20% of the surface area of the assembled article.

11. The air permeable adhesive article of claim 9, wherein the adhesive-carrying carrying fabric layer having an overall open area of at least about 25% of the surface area of the assembled article.

12. The air permeable adhesive article of claim 9, wherein the adhesive-carrying carrying fabric layer having an overall open area of at least about 30% of the surface area of the assembled article.

13. The air permeable adhesive article of claim 1, 5, or 9, wherein the porous backing substrate is a porous film.

14. (canceled)

15. (canceled)

16. The air permeable adhesive article of claim 1, 5, or 9, wherein the fabric of the adhesive-carrying fabric layer comprises warp yarns running in the machine direction and weft yarns running in the cross direction, the weft yarns having a higher denier than the warp yarns.

17. The air permeable adhesive article of claim 16, wherein the warps yarns have a denier in the range of 20 to 80, and the weft yarns have a denier in the range of 50 to 200.

18. (canceled)

19. (canceled)

20. The air permeable adhesive article of claim 16, wherein the warps yarns have a denier in the range of about 30.

21. (canceled)

22. The air permeable adhesive article of claim 16, wherein the weft yarns have a denier in the range of about 70.

23. (canceled)

24. (canceled)

25. (canceled)

26. (canceled)

27. (canceled)

28. The air permeable adhesive article of claim 16, wherein the warps yarns have a density in the range of 9 yarns/inch to 24 yarns/inch, and the weft yarns have a density in the range of 9 yarns/inch to 18 yarns/inch.

29. The air permeable adhesive article of claim 16, wherein, the warp yarns have a denier of about 30 and a density of about 18 yarns/inch, and the weft yarns have a denier of about 70 and a density of about 12 yarns/inch.

30. The air permeable adhesive article of claim 16, wherein the article is hand-tearable in the cross direction.

31. (canceled)

32. (canceled)

33. The air permeable adhesive article of claim 1, 5, or 9, wherein an inner face of the porous backing substrate contacts and adheres to an inner face of the adhesive-carrying fabric.

34. The air permeable adhesive article of claim 33, wherein the adhesive bonds the inner face of the porous backing substrate to the inner face of the adhesive-carrying fabric.

35. The air permeable adhesive article of claim 33, wherein the porous backing substrate is an apertured plastic film.

36. The air permeable adhesive article of claim 33, wherein the porous backing substrate is an apertured plastic film and the adhesive is a pressure-sensitive adhesive.

37. The air permeable adhesive article of claim 33, wherein the porous backing substrate is an apertured plastic film and the adhesive is selected from the group consisting of: polyacrylate adhesives, polyalphaolefin adhesives, styrene-butadiene adhesive, styrene-ethylene/butylenes adhesives, styrene-isoprene adhesives, polyvinyl acrylate adhesives, natural rubber resin adhesives, synthetic rubber resin adhesives, silicone adhesives, polydiorganosiloxane polyurea copolymer adhesives, polyurethane adhesives, urethane copolymer adhesives, and mixture and blends thereof.

38. The air permeable adhesive article of claim 33, wherein the adhesive is an acrylic resin.

39. (canceled)

40. (canceled)

41. (canceled)

42. (canceled)

43. The air permeable adhesive article of claim 1, 5, or 9, wherein the porous backing substrate is a porous film.

44. The air permeable adhesive article of claim 43, wherein the porous film comprises plastic.

45. The air permeable adhesive article of claim 43, wherein the porous film comprises a material selected from the group consisting of: natural rubber, synthetic rubber, balata, and gutta-percha.

46. The air permeable adhesive article of claim 43, wherein the porous film comprises an elastomer selected from the group consisting of: polybutadiene, ethylene-propylene terpolymer (EPDM rubber), styrene-butadiene copolymer, polychloroprene (neoprene), nitrile rubber, butyl rubber, polysulfide rubber, silicone rubber, polyurethane rubber, polyisobutylene, natural rubber, and acrylate rubber.

47. (canceled)

48. (canceled)

49. (canceled)

50. The air permeable adhesive article of claim 43, wherein the porous film is an apertured film.

51. The air permeable adhesive article of claim 43, wherein the porous film is an apertured plastic film.

52. The air permeable adhesive article of claim 51, wherein the plastic is polyethylene.

53. The air permeable adhesive article of claim 51, wherein the plastic is selected from the group consisting of: polyvinyl chloride, polyproplylene, polystyrene, polyurethane and polyester (Mylar).

54. The air permeable adhesive article of claim 51, wherein the plastic comprises a polymer or a co-polymer of a monomer selected from the group consisting of: ethylene, propylene, butylene, vinyl chloride monomer, styrene monomer, and urethane monomer.

55. The air permeable adhesive article of claim 51, wherein the apertured plastic film is corona-treated prior to assembly of the article.

56. The air permeable adhesive article of claim 50, wherein the apertured film is made from a film material that is about 10 micrometers to about 300 micrometers thick.

57. The air permeable adhesive article of claim 51, wherein the apertured plastic film is made from a plastic film that is about 0.0005 inches to about 0.010 inches (0.5 to 10 mils, 0.00127 to 0.0253 cm) thick.

58. The air permeable adhesive article of claim 57, wherein the apertured plastic film is made from a plastic film that is about 0.001 inches to about 0.005 inches (1 to 5 mils) thick.

59. The air permeable adhesive article of claim 57, wherein the apertured plastic film is made from a plastic film that is about 0.0025 inches (2.5 mils) thick.

60. The air permeable adhesive article of claim 50, wherein the apertured film has at least about 20% open area.

61. The air permeable adhesive article of claim 50, wherein the apertured film has at least about 24% open area.

62. The air permeable adhesive article of claim 50, wherein the apertured film has about 20% to about 30% open area.

63. (canceled)

64. (canceled)

65. (canceled)

66. (canceled)

67. The air permeable adhesive article of claim 51, wherein the apertured plastic film is extensible in the machine direction by at least about 10%.

68. (canceled)

69. (canceled)

70. An article comprising:
a porous backing substrate; and
an adhesive-carrying fabric applied to a surface of the backing substrate, the fabric having a porosity greater than that of the backing substrate and the adhesive of the adhesive-carrying fabric located on the fabric in such a manner that the fabric remains porous.

71. An article comprising:
a porous backing substrate; and
an adhesive-carrying fabric applied to a surface of the backing substrate, the fabric having a porosity greater than that of the backing substrate and comprising warp yarns running in the machine direction and weft yarns running in the cross direction, the weft yarns having a higher denier than the warp yarns, and the adhesive of the adhesive-carrying fabric located on the fabric in such a manner that the fabric remains porous.

72. (canceled)

73. (canceled)

74. The article of claim 70 or 71, wherein the adhesive-carrying fabric is selected from the group consisting of woven, non-woven and knit fabrics.

75. The article of claim 70 or 71, wherein the porous backing substrate is a porous film.

76. The article of claim 75, wherein the porous film is an apertured plastic film.

77. The article of claim 75, wherein the apertured plastic film is polyethylene or a copolymer thereof.

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)
